(19) United States
(12) Patent Application Publication
(10) Pub. No.: US 2017/0023174 A1
(43) Pub. Date: Jan. 26, 2017

(54) Walking aid attachment and leg support apparatus

(71) Applicant: Wesley Harmon, Missoula, MT (US)

(72) Inventor: Wesley Harmon, Missoula, MT (US)

(21) Appl. No.: 15/197,731

(22) Filed: Jun. 29, 2016

Related U.S. Application Data
(60) Provisional application No. 62/186,948, filed on Jun. 30, 2015.

(51) Int. Cl. F16M 13/02; A47C 7/52; A47B 97/00; A61H 3/02

(52) U.S. Cl. CPC F16M 13/022; A61H 3/02; A47C 7/52; A47B 97/00; A61H 2003/005

(57) ABSTRACT

This invention relates to leg supports that can be easily mounted and removed from a suitable frame, such as walking aids, chairs or table legs, positioned at a height on said frame chosen by a user where said leg support can be easily deployed or stowed at the discretion of a user.

This patent application claims priority to provisional patent application 62/186,948, filed 30 Jun. 2015.

### BACKGROUND

Definitions: For the purposes of this patent application the following definitions should apply. The lower portion of a crutch refers to that part of a crutch in which the three parallel bars comprising a crutch such as that shown in FIG. 1 abut one another. FIG. 1 identifies this part of the crutch as that section of crutch being located between the point identified as 32 and the point identified as 36. A more detailed description of this part of the crutch is included later in this disclosure. Parallel to the crutch refers to the leg support arm being substantially parallel to the aforementioned three parallel bars comprising a crutch as in FIG. 1. Though the following disclosure refers to a crutch by way of examples, it should be understood that it is contemplated and within the scope of this innovation that the approach described and taught in this disclosure can be applied to a wide variety of frames including but not limited to walkers, canes and similar walking aid devices, chairs, tables and other similar frames. The word frame, in the context of this innovation refers to an object or multitude of objects upon which the innovation can be firmly attached by way of compression. Said frame further can be characterized as having an outside diameter such that the inner diameter of the described attachment collar can be compressed about the outside diameter of the frame resulting in a compressive attachment capable of supporting the weight of a leg when placed upon a leg support attached to the attachment collar. The use of crutch is by way of example and not to be considered a limitation.

This invention relates to a low profile leg support that can be mounted on a frame to support a user's leg thereby resting it as required or desired by a user.

Many people who either have a permanent leg, knee, hip or foot disability or are recovering from a leg, knee, hip or foot injury or operation and are required to use crutches so as to allow the appendage to rest and recuperate while still enabling ambulation.

Crutches have taken many forms over the years, and all have been designed to permit a user to ambulate while minimizing use of a single leg. That is, to be able to ambulate without the need to place all or part of the user's body weight on the user's leg(s). Even so, known crutches have not addressed the needs of many users, in particular to be able to easily and comfortably rest the affected leg by supporting it while in the standing position.

An individual using crutches may often find themselves in a location lacking a supportive object such as a table, chair or cushion to support their injured leg. Raising an injured leg is known to be both beneficial to healing and to offer a modicum of pain relief. Raising an injured leg results in a decrease of the internal pressure (from blood, lymph etc.) in the affected region. As a result of reduced pressure, swelling and pain are reduced. Changing the relative position of an injured leg, i.e. by bending at the knee, is also known to offer a modicum of pain relief and can increase range of motion. Ambulation with crutches can also result in asymmetrical body movement, which can unduly stress the users back, especially the lumbar region. The ability to rest an affected leg with ease and at the discretion of the user can offer an immediate reduction in back tension in a users back.

This invention addresses this long felt and unmet need by providing a leg support that can be readily attached to a conventional crutch, and which provides a support whereon a user can rest the affected leg with convenience and ease.

The leg support of the present invention can be used by most anyone requiring a crutch as a result of its adjustability along the length of the lower member of the crutch, and a single design is interchangeable for use with, and on either side, of most commercially manufactured crutches as are commonly known in the art. The leg support of the present invention can be manufactured in any suitable conventional manner, i.e. by casting, fabrication, molding, forming or 3D printing. The leg support of the present invention can be made of any suitable material, i.e. metal, plastic, wood, resin, ceramic, nylon or mixtures thereof just as long as it has sufficient mechanical strength to provide the required support and can survive multiple uses and relocations with little degradation in performance. It should be understood that the aforementioned manufacturing techniques and material listings are in no means to be considered limitations of the technology, rather they are offered as examples of amenable embodiments of the innovation.

Given the need to resolve the aforementioned issues, a number of patent and patent applications have been filed in an attempt to address one or more of these concerns. Information relevant to said patents and patent applications can be found in U.S. Pat. Nos. 751,942, 2,495,889, 2,678,054, and US 2001/0032661 A1. However, each one of these references suffers from one or more of the following disadvantages. They do not offer a system that is easily and readily deployed or stowed, they do not offer a system which can easily be adjusted from one height to another, they do not offer a system which does not require crutch modifications (e.g. drilling holes, welding, glue), they do not offer a system amenable to being used when a user is standing, they do not offer a system which can be easily mounted and removed from a standard crutch.

Thus, there remains a need for a walking aid leg support, which is easy to use, amenable to customization by the user and can be easily attached and detached from a standard crutch.

It is an objective of this innovation to provide a leg support system, which can be easily stowed and easily deployed.

It is a further objective of this innovation to provide a leg support system, which can be secured to a crutch across a large choice of vertical heights.

It is a further objective of this innovation to provide a leg support system, which offers a secure and solid perch for a users foot

It is a further objective of this innovation to provide a leg support system that can be attached to a standard crutch without the need to change said crutch in any way.

It is a further objective of this innovation to provide a leg support system that can be easily mounted and easily removed from a crutch.

It is a further objective of this innovation to provide a leg support system which provides auditory confirmation to a user when pivoting from one position, e.g. stowed or deployed, is fully complete.

It is a further objective of this innovation to provide a leg support system, which offers a surface amenable to inclusion of a logo or similar marketing paraphernalia.

It is a further objective of this innovation to provide a leg support system, which offers a low profile and unobtrusive leg support.

### SUMMARY

The present invention is directed to detachable leg support that can be mounted on a walking aid at a variety of vertical heights to support a user's leg thereby resting it as required or desired by a user.

According to the invention a walking aid attachment and leg support apparatus comprises a means for attachment to a walking aid at a variety of vertical positions; means for supporting a user's leg in an elevated position and an means to easily stow or deploy said support at a users discretion. In a preferred form of the invention, the attachment means comprises a collar (the attachment collar) which can be attached to a walking aid, such as a crutch, such that a user can select a position upon said crutch anywhere along the lower portion of said crutch. Said lower portion of a crutch is defined elsewhere in this text. Said attachment collar is produced from a resilient yet physically strong material capable of securely engaging said crutch and supporting the weight of the leg resting upon a pivotally attached leg support arm.

Also in a preferred embodiment of the invention, the means for supporting a leg at an elevated position comprises a short leg support arm for supporting a foot placed upon said leg support arm which is positioned substantially horizontal to the crutch upon which it is attached. Said leg support arm is pivotally attached to said attachment collar enabling said arm to be pivoted substantially perpendicular to said crutch when support is require or parallel to said crutch when not required.

Further in a preferred embodiment of the invention, when said leg support arm is pivoted substantially parallel to the crutch, termed the stowed position, said leg support arm does not interfere with the use thereof of, i.e. ambulation, with said walking aid. In said stowed position, the invention is low profile and unobtrusive.

In the preferred form of the invention, the components of the innovation are lightweight yet sufficiently strong to both support a leg, remain in the secured position along said crutch and survive numerous pivotings, relocations, removals and recommissionings along and on said crutch.

### BRIEF DESCRIPTION OF THE DRAWINGS

FIG. 1: Schematic representation of standard crutch

FIG. 2a: Top view of crutch attachment

FIG. 2b: Perspective view of crutch attachment

FIG. 2c: Front view of crutch attachment

FIG. 2d: Right view of crutch attachment

FIG. 3a: Top view of leg support arm

FIG. 3b: Side view of leg support arm

FIG. 3c: Front view of leg support arm

FIG. 3d: Right view of leg support arm

FIG. 4a: Perspective view of the fully commissioned leg support system in stowed position

FIG. 4b: Side view of the fully commissioned leg support system in stowed position

FIG. 5a: Perspective view of the fully commissioned leg support system in deployed position

FIG. 5b: Side view of the fully commissioned leg support system in deployed position

FIG. 6: Side view of the fully commissioned single node leg support arm system

FIG. 7: Perspective view of the backside of a fully commissioned leg support system in deployed position with a logo

FIG. 8: Top view of attachment collar with quick release securement system.

FIG. 9: Top view of two piece attachment collar

FIG. 10: Side view of two piece attachment collar

FIG. 11a: Exploded view of a two piece collar attachment.

FIG. 11b: Side view 1 of a mounted two piece collar attachment.

FIG. 11c: Side view 2 of a mounted two piece collar attachment.

FIG. 12a: Top view of square attachment collar.

FIG. 12b: Side view of square attachment collar.

### DESCRIPTION

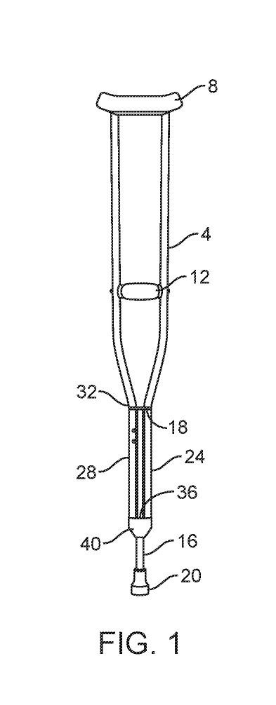

The present invention will now be described in reference to FIGS. 1 through 8. It is understood that the present invention may be embodied in many different forms and should not be construed as being limited to the embodiments set forth herein. Rather these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention. However, it will be clear to those of ordinary skill in the art that the present invention may be practiced without such specific details. The description given herein is for explanatory purposes and that it is nevertheless understood that no limitation of the scope of the invention is intended.

Referring to now to FIG. 1, a crutch frame (4) has a top end with a foam pad (8) disposed thereon. The top end is for placing under a users underarm. A handle (12) is disposed in the approximate middle of the crutch frame. A central shaft (16) is disposed at the bottom end of the crutch frame (4). The central shaft (16) has a first end (18) and a rubber tip (20) disposed on a second end. The rubber tip (20) contacts the ground surface when a user uses the crutch device. Said central shaft (16) has disposed on two sides, two parallel shafts, shaft 1 (24) and shaft 2 (28) that secure said central shaft (16) to the crutch frame (4). Said central shaft (16) can be secured to said two parallel shafts, parallel shaft 1 (24) and parallel shaft 2 (28), in a variety of positions thereby offering a variety of total vertical lengths of said crutch frame (4) and hence enabling users of different heights to use said crutch frame (4). The crutch frame (4) has a central shaft top interface (32). Said central shaft top interface (32) is defined as the top most interface whereby the central shaft (16), parallel shaft 1 (24) and parallel shaft 2 (28) are in physical contact and share the same horizontal plane. Said central shaft top interface (32) changes vertical location as a function of crutch frame height adjustment. The central shaft bottom interface (36) is fixed to a location just above the topmost, i.e. most vertical, plane of the bottom bracket (40) which secures said central shaft (16) directly between and in the same horizontal and vertical planes as parallel shaft 1 (24) and parallel shaft 2 (28). That part of the crutch frame between the central shaft top interface (32) and the top most end of the bottom bracket (40) defines that part of the crutch frame (4) upon which the innovation, by way of the attachment collar, can be mounted.

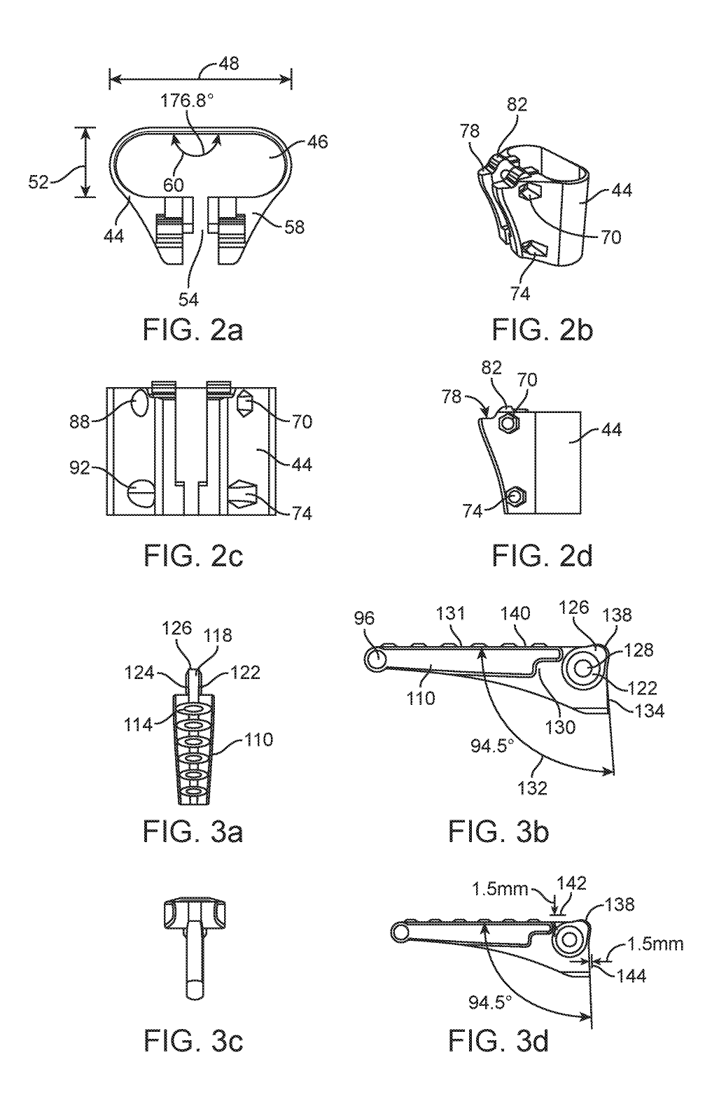

Referring now to FIGS. 2a, 2b, 2c and 2d, which show four different perspectives of the attachment collar portion of the innovation. Referring to FIG. 2a shows a top view of the attachment collar (44). Said attachment collar (44), also termed a vertical member, has a central void (46) with an associated central void length (48) and central void width (52) which approximately match the standard dimensions of the central shaft (16), parallel shaft 1 (24) and parallel shaft 2 (28) when physically secured for standard crutch operation. Said attachment collar (44) has a central gap (54), which accommodates securement of the leg support not shown and offers sufficient compression and release so that said attachment collar (44) can be tightened and loosened about a standard crutch. Such tightening and loosening systems are known in other mechanical binding systems. The attachment collar (44) is constructed such that attachment collar flange (58) is thicker closer to the central void (46) than it is farther from the central void (46), when viewed from the top view. This variation in thickness enables both the required physical strength to be secured to a crutch in a sufficient manner to not move upon securement and meet the mechanical requirements to associated with the requisite stress due to the securing bolts (not shown) when in the secured position, minimization of weight of the total system and a lessening of intrusion of the attachment collar (44) perpendicular to the crutch upon which it is mounted. The side of the attachment collar (44) opposite the central gap (54) is designed with a curve whose angle is less than 180 degrees. Said curve, called the crutch gap angle (60), is utilized to better accommodate the size differences between the central shaft (16) and the two parallel shafts, parallel shaft 1 (24) and parallel shaft 2 (28). Said central shaft (16) is commonly larger than the two parallel shafts. Inclusion of said crutch gap angle (60) enables a more secure grip on the three shafts and reduces resulting stress on the attachment collar (44) by pre accommodating the size differences. In a preferred embodiment, an angle of 176.8 degrees was found to closely match the differences found in a standard crutch assembly. It should be understood that angles slightly larger and smaller are contemplated as amenable to practicing the disclosed innovation.

Referring now to FIG. 2b shows a perspective of the attachment collar (44). Two self locking nut ingresses, top nut ingress (70) and bottom nut ingress (74) enable proper positioning and in situ securement of a nut which in conjunction with it's mating screw facilitate compression of the attachment collar (44) thereby firmly securing it to the crutch assembly at a position chosen the by the user. Utilization of the top nut ingress (70) and the bottom nut ingress (74) enables rapid securement, rapid relocation and removal of the attachment collar (44). Though screws and nuts are disclosed in this example, it should be understood that quick release mechanisms of the type commonly used with bicycle wheels can be used replacing screws and nuts. The use of quick releases is contemplated within the scope of this innovation. Further, other types of screws and nuts (i.e. barrel nuts, Chicago screws, post and screw, sex nuts, binding screws etc. are known in the art and deemed applicable to the innovation. Said attachment collar (44) is designed with a leg support shelf (78) designed to match the underside of the leg support arm, not shown, and provide improved stability for the leg support arm and efficient transference of user weight to the attachment collar (44) and in turn the crutch itself.

Referring now to FIG. 2c shows a front perspective of the attachment collar (44). The top nut ingress (70) and the bottom nut ingress (74) are seen on the right side of FIG. 2c. This view shows that both aforementioned ingresses are tapered to match the different thickness of the attachment collar flange (58) as previously described. The size and depth of the ingress are such that they provide sufficient securement of the associated nut, which fits into said ingresses, thereby providing a system, which does not require a wrench, socket or other similar tool, to secure or remove from a mounted position. Further, said tapered ingress enables simpler mold design and speaks to assisting said mold release from the materials used to manufacture the parts. That is, the design element described also facilitates ease of manufacturing, in particular mold release if parts are produced by injection molding or similar mold related techniques. The aforementioned taper results in wedging the nut placed in it in a secure position. By taper in the context of this explanation can also be described as being conically shaped the smaller diameter of the cone being closer to the central gap (54). The top screw ingress (88) and the bottom screw ingress (92) are positioned axially consistent with the top nut ingress (70) and the bottom nut ingress (74) respectively. The alignment of the screw ingresses and nut ingresses are such that a screw passing through the screw ingress is aligned with the associated nut ingress thereby facilitating easy connection between the two parts.

Referring now to FIG. 2d shows a right perspective of the attachment collar (44). FIG. 2b shows the top nut ingress (70), the bottom nut ingress (74) and the leg support shelf (78) as previously described. FIG. 2d further shows an attachment collar bump (82) which facilitates securement of the leg support arm (not shown) when in the stowed position.

Referring now to FIGS. 3a, 3b, 3c and 3d, which show four different perspectives of the leg support arm portion of the innovation. FIG. 3a shows a top perspective of the leg support arm (110). Said leg support arm (110), also termed a lateral member, has disposed upon it foot support studs (114). In the embodiment described, said leg support arm (110) has six foot support studs (114). Said foot support studs (114) increase the traction of a foot placed upon it, thereby decreasing the incidence of foot slippage upon said leg support arm. Said foot studs (114) also assist in efficient and predictable transference of weight from said leg support arm (110) to the attachment collar due to lessening the incidence of foot slippage, which can result in rapid increase in pressure on the leg support arm (110). Though this embodiment shows six support studs, it should be understood that more or less studs can be used and are contemplated within the scope of this invention. A leg support arm central support (118) bisects the leg support arm (110) facilitating a matched connection via a pivot and increased structural support between the leg support arm (110) and the attachment collar (44) when the two pieces are engaged. A right leg support guide bushing (122) and left leg support guide bushing (124) can be seen on either side of said leg support arm central support (118) located at the pivotal end (126) of said leg support arm (110). Said leg support guide bushings provide for efficient pivotal movement between the leg support arm (110) and the attachment collar (44) when the two separate pieces are attached to one another. The integrated bushings further facilitate smooth pivoting action, optimal alignment between the two distinct pieces, the leg support arm (110) and the attachment collar (44), and increase the physical strength of the fully commissioned system by limiting movements outside of the defined pivotal frame. That is, torsional and angular movements being the defined pivotal plane are limited.

Referring now to FIG. 3b shows a right view of the leg support arm (110). The right leg support guide bushing (122) can be seen on the pivotal end (126) of said leg support arm (110). A connection via (128) can be seen near the pivotal end (126). Said connection via (128) aligns with the top nut ingress (70) and the top screw ingress (88) such that a screw, bar, rod, pipe or similar physical means can be passed through said connection via (128), top nut ingress (70) and the top screw ingress (88) in an unimpeded manner. Said screw, bar, pipe or similar physical means enables connection between the crutch attachment (44) and the leg support arm (110). It should be understood that a quick release mechanism of the type commonly used with bicycle wheels can be used with said connection via (128) and is contemplated within the scope of this innovation.

A leg support divot (130) can be found on the underside of the leg support arm (110). Said leg support divot (130) is designed to match and fit snuggly into the leg support shelf (78), not shown, as previously described. Said leg support divot (130) and said leg support shelf (78) add structural stability to the leg support arm (110) when engaged to the attachment collar (44) in a perpendicular orientation. Said leg support divot (130) and said leg support shelf (78) when engaged and snuggly positioned to one another inhibit lateral and rotational movement upon engagement but do not inhibit pivotal movement between the leg support arm (110) and attachment collar (44). Said leg support divot (130) and said leg support shelf (78) further add torsional rigidity to the leg support arm (110) and attachment collar (44) when in the pivotally engaged position, that is, when the leg support arm (110) and attachment collar (44) are positioned at an angle of 94.5 degrees in relation one another when measured from the top of the leg support arm (131) and a position bellow the attachment collar (44) on said crutch (150). The angle (132) being slightly over perpendicular, that is greater than 90 degrees, when measured from the engagement side of the leg support arm (134), is beneficial as it compensates, in situ, for the weight distribution of a foot and or leg, when positioned on said leg support arm (110). The compensation in angle enables flexion of said leg support arm while still maintaining at least a 90 degree angle between said leg support arm (110) and the crutch upon which it is attached. Said angle greater than 90 degrees also increases the traction between a foot positioned on said leg support arm (110) and conveys to the user a feeling of stability upon engagement of the leg support arm. Contemplated angles range from just greater than 90 degrees, i.e. 90.1 to 100 degrees, to 110 degrees. Choice of degree is a function of materials of construction with softer materials, or materials that have more flexion upon use demanding higher degrees of angulation.

FIG. 3b further shows the engagement side of the leg support arm (134) which, upon engagement with the attachment collar (44), defines a greater than perpendicular orientation, that is greater than 90 degrees between leg support arm (110) and attachment collar (44). That is, when the leg support arm (110) and attachment collar (44) are pivotally attached to one another, with the center of said pivot being the horizontal axis defined as the center of the leg support guide bushings, said engagement side of the leg support arm (134) abuts against said attachment collar (44) when in the deployed position thereby stopping any further angular movement and positions said leg support arm (110) firmly against the attachment collar (44). FIG. 3b further shows a leg support arm protrusion (138). Said leg support arm protrusion (138) protrudes beyond the plane produced by the top most edge of the leg support arm (140) and the engagement side of the leg support arm (134). That is, said leg support arm protrusion (138) extends the corner beyond the plane upon which these two planes intersect. Said protrusion extension is further discussed in FIG. 3d. Said protrusion, also termed a ramp or angled ramp, results in an increased tension on the pivot arm during pivoting and increased securement in both the deployed and stowed positions of said leg support arm (110) due to its extension beyond the plane of the top most edge of the leg support arm (140) and the plane of the engagement side of the leg support arm (134) respectively. In other words, the protrusion, ramp or angled ramp on the attachment collar, is positioned such that said leg support arm abuts against the protrusion, ramp or angled ramp thereby increasing pressure between said leg support arm and said attachment collar when said leg support arm is rotated between a substantially parallel orientation to said attachment collar to a substantially perpendicular orientation to said attachment collar and said pressure is released when said leg support arm is positioned substantially parallel to said attachment collar. Though a ramp is positioned on the attachment collar, it can also be positioned on the leg support arm such that the protrusion abuts against the attachment collar. The release of said tension at the end of the pivoting motion results in an acceleration of the leg support arm (110) such that it's impact with attachment collar (44) results in an audible sound when the two pieces come into contact with one another. Said audible sound alerts the user that the leg support arm (110) has reached either the deployed or stowed position, depending on which way said pivot action took place. Said protrusion also increases the securement in both the stowed and deployed positions by physically increasing the distance and hence tension between the leg support arm (110) and the surface upon which it is engaged, specifically the attachment collar (44) and or the crutch upon which it is mounted. By deployed position we refer to the leg support arm (110) producing an angle greater than 90 degrees with the crutch upon which the attachment collar is secured. By stowed position we refer to the leg support arm (110) being essentially in a parallel orientation to the crutch upon which the crutch attachment is secured.

FIG. 3b further shows a leg support catch (96) which facilitates a user manipulating said leg support arm (110) from the stowed position to the deployed position. Said leg support catch (93) extends and protrudes beyond the plane of both the top side and bottom side of the leg support arm (110).

Referring now to FIG. 3d, shows leg support arm protrusion (138) and the vertical protrusion distance (142) which shows the distance which the protrusion protrudes vertically when in the deployed position and the horizontal protrusion distance (144) which shows the distance which the protrusion protrudes horizontally when in the deployed position. In this embodiment said vertical protrusion distance (142) is 1.5 mm and said horizontal protrusion distance (144) is 1.5 mm. Protrusion distances as small as 0.5 mm and as large as 7 mm are contemplated in this innovation. Further, protrusion comprised of both hard and soft materials are contemplated in this innovation. In general, softer materials can be used with large protrusion distances, while harder materials tend to perform better with smaller protrusion distances.

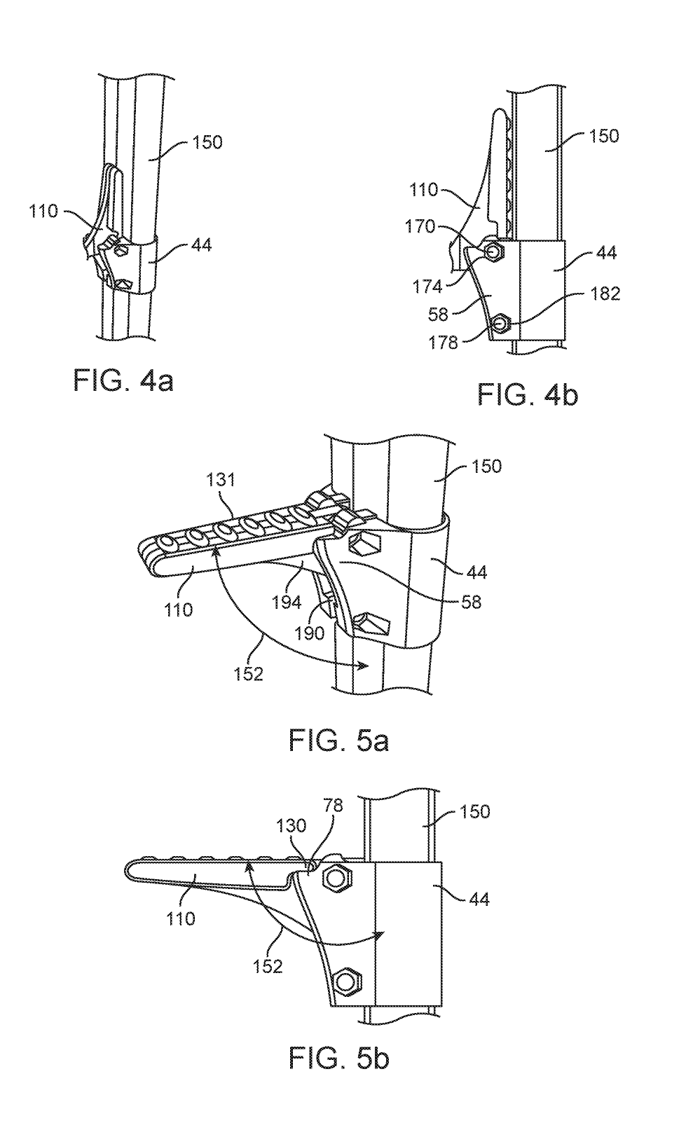

Referring now to FIG. 4a, which shows a perspective view of the fully commissioned leg support system, that is, both the attachment collar (44) and the leg support arm (110) attached to one another, mounted to a crutch (150). FIG. 4a shows the fully commissioned leg support system in the stored position. Said stored position is defined as that position in which the leg support arm (110) is parallel to the crutch (150). Said stored position provides easy user access to said leg support system and a minimization of intrusion into the space required for a human leg to travel during standard ambulation as known in the art.

Referring now to FIG. 4b, which shows a right view of the fully commissioned leg support system in the stored position. The attachment collar (44) and the leg support arm (110) are attached to one another via a top securement screw (170) which is engaged with a top securement nut (174) as is known in the art. Said attachment collar is attached by means of compression to the crutch (150). Said means of compression is due to the pressure produced by the top securement screw (170) being engaged to the top securement nut (174) and the bottom securement screw (178) being engaged to the bottom securement nut (182) compressing of the two sides of the attachment collar flange (58) across the flange gap (not shown in FIG. 4b). Both top and bottom securement screws can be tightened or loosened as is known in the art. Tightening the securement screws secures the attachment collar (44) to the crutch (150). Loosening said securement screws enables removal and/or repositioning of said attachment collar (44) on or from said crutch (150).

Referring now to FIG. 5a, which shows a perspective view of the fully commissioned leg support system in the deployed position. By deployed we refer to the leg support arm (110) being pivoted such that the top of said leg support arm (131) forms an angle greater than 90 degrees (152) to the crutch (150) upon which the attachment collar (44) is secured, where said angle is measured from the top of said leg support arm (131) to a position bellow the attachment collar (44) on said crutch (150). The flange gap (190) is located between the two sides of the attachment collar flange (58). Said flange gap (190) enables compression of the attachment collar (44) such that it secures to the crutch (150) upon tightening of the securement screws and provides egress for the leg support flange (194).

Referring now to FIG. 5b shows a right view of the fully commissioned leg support system in the deployed position. As previously described, the leg support arm (110) has been pivoted such that it forms a 94.5-degree angle with the crutch (150) upon which the attachment collar (44) is secured. The leg support divot (130) is engaged onto the leg support shelf (78) providing increased structural support and weight transference between said leg support arm (110) and the attachment collar (44) and subsequently to the crutch (150) itself. Engagement of the leg support divot (130) to the leg support shelf (78) also provides increased torsional rigidity. Engagement of the leg support divot (130) to the leg support shelf (78) increases horizontal, vertical, torsional rigidity and physical strength between the leg support arm (110) and the attachment collar (44).

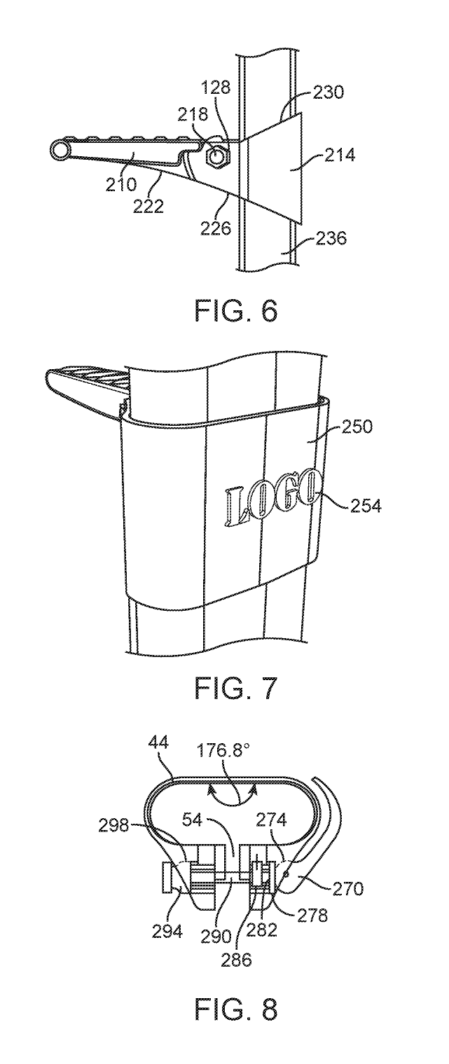

Referring now to FIG. 6 shows a fully commissioned single node leg support arm (210). Said single node leg support arm (210) has a connection via (128) as previously described. Said single node leg support arm (210) is shown connected to a single node attachment collar (214). The single node system is shown in the deployed state in FIG. 6. Said single node system utilizes a single securement screw (218). Said securement screw (218) can be substituted with other securement systems such as quick releases, cotter pins systems, compression screws and other means capable of compressing and decompressing said single node attachment collar (214) as previously described. The curvature of the bottom of said single node leg support arm (222) is matched to the curvature of the bottom of said single node attachment collar (226) thereby increasing the efficiency of weight transference from said single node leg support arm (210) to said single node attachment collar (214). Similarly, the angle of the top of said single node attachment collar (230) is chosen such that it facilitates efficient and effective weight transference between said single node leg support arm (210) through said single node crutch attachment (214) to the crutch section (236) upon which it is attached.

Referring now to FIG. 7 shows the backside of fully commissioned leg support system in deployed position with a logo position (254) shown on the backside of the attachment collar (250). Said logo position (254) enables a logo, picture, words or advertisement can be secured, imprinted, painted, drawn, pressed, etched, carved or otherwise displayed. Though a specific logo position (254) has been shown in this embodiment, it is understood that other positions on the surface or interior of the innovation are contemplated as being part of this invention disclosure and are considered part of the innovation described.

Referring now to FIG. 8 which shows a quick release mechanism installed in an attachment collar. Quick release mechanisms are known in the art and a number of different quick release systems are applicable to the described innovation. FIG. 8 shows the use of one standard quick release system in an attachment collar. FIG. 8 shows quick release lever (270) positioned in a quick release ingress (274). Said quick release ingress (274) is shaped to accommodate the quick release lever and associated quick release componentry in a snug but not constricting manner. A cam follower (278) is positioned such that it engages the rotation end of the quick release as is known in the art. A spring (282) and a spring cup (286) are positioned axially along the quick release bar (290) applying a modicum of opposing pressure to the quick release lever (270). A quick release nut (294) is positioned in a quick release nut ingress (298) thereby enabling locking of the quick release system across the central gap (54).

Said leg support arm (110) and/or single node leg support arm (210) can be deployed or stowed by physically positioning said arm in either position. That is, a user can with their foot, hand or tool simply move said arm into the desired position.

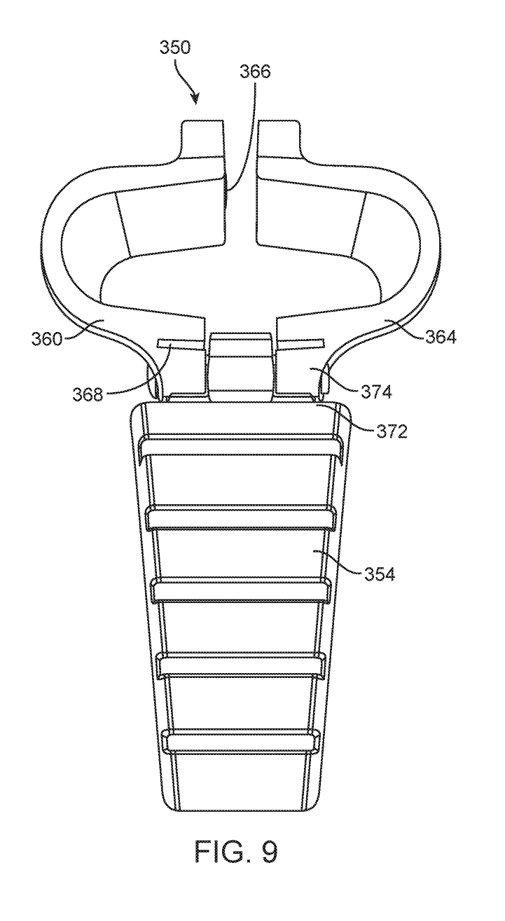

Referring now to FIG. 9, which shows a two piece attachment collar (350) and leg support arm (354) positioned in the deployed position. Said two piece attachment collar (350) is comprised of two collar sleeves, sleeve 1 (360) and sleeve 2 (364) which together facilitate attachment to a crutch by way of compression. Said two sleeves, sleeve 1 (360) and sleeve 2 (364), are aligned such that they can be secured to one another by screws and/or bolts which pass through both sleeves, via purpose designed thru holes, as is known in the art. In regards to this invention, we define sleeve as “a part designed to fit over another part”. In exemplary embodiments said two sleeves are substantially identical. Being substantially identical is not required to practice the innovation, however, in exemplary embodiments said two sleeves are produced by a single mold. The use of a single mold to produce two sleeves enables significant cost savings in regards to production, reduction of inventory, ability to easily replace individual parts with a standard part and simplification of the system as a whole.

A single sleeve design becomes two matching parts by simply rotating one of two said sleeves, such that it's primary flat surface (366) is essentially mirrored by the primary flat surface of the sleeve which was not rotated. Specific examples of rotating methodology are described below. The rotation of one of the two sleeves relative to the other results in an essentially rotationally symmetric system that can be readily attached to one another. The use of rotationally symmetric sleeves enables the use of a single mold to produce the two sleeves required to attach the two sleeve system, i.e. attachment collar, to a frame. Examples of said rotational symmetry can be further seen in FIGS. 9, 10, 11 and 12.

The two piece collar attachment (350) also has a leg support locking divot (368), a leg support locking protrusion (372) and a ramp (374), which in concert provide an increase in pressure between the leg support arm (354) and the attachment collar (350) when said leg support arm (354) is moved from the deployed position to the stored position, and visa versa i.e. stored position to deployed position. By deployed position we mean that said leg support arm (354) is essentially 90 to a frame when mounted and by stored position we mean that said leg support arm (354) is essentially parallel to a frame when mounted. Said leg support arm (354) essentially abuts against said ramp (374) which is slightly proud of the surface of the attachment collar thereby providing pressure during the aforementioned movement. Said locking divot (368) and said leg support locking protrusion (372) essentially mesh with one another thereby securing the leg support when in the stored position. A second locking divot, second ramp and second leg support locking protrusion secure the leg support in the deployed position. The second locking divot, second ramp and second leg support locking protrusion are not visible in FIG. 9. In preferred embodiments both locking protrusions make an audible noise upon engagement with their meshed divots by way of mechanical impact.

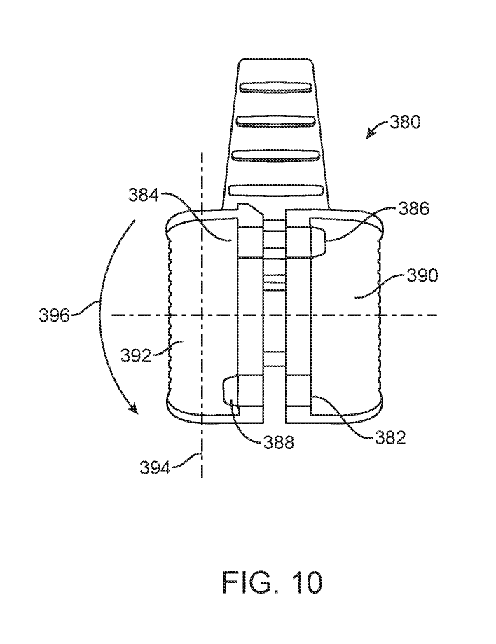

Referring now to FIG. 10, which shows a side view of a two piece collar attachment (380). The collar pieces have screw holes, screw hole 1 (382) and screw hole 2 (384) which are used to assist in securing the collar pieces, sleeve 1 (390) and sleeve 2 (392) respectively, to the frame upon which they are attached. Said screw holes, (382) and (384), have extra material, (388) and (386) respectfully, such that they protect a user from excess screw material if a screw longer than the screw hole is used. As can be seen in FIG. 10, a single sleeve design has been used to provide both required sleeves, with one sleeve rotated 180 degrees such that it results in a rotationally symmetric orientation between the two said sleeves. Rotational symmetry of the single sleeve design, in this embodiment, is a result of rotating said sleeve 180 about a first axis, axis a (394). In the direction dictated by arrow (396). It should be understood that other similar methodologies, i.e. rotational regimes, for achieving the required rotational symmetry exist and the aforementioned rotations are offered as a single method to achieve the desired symmetry.

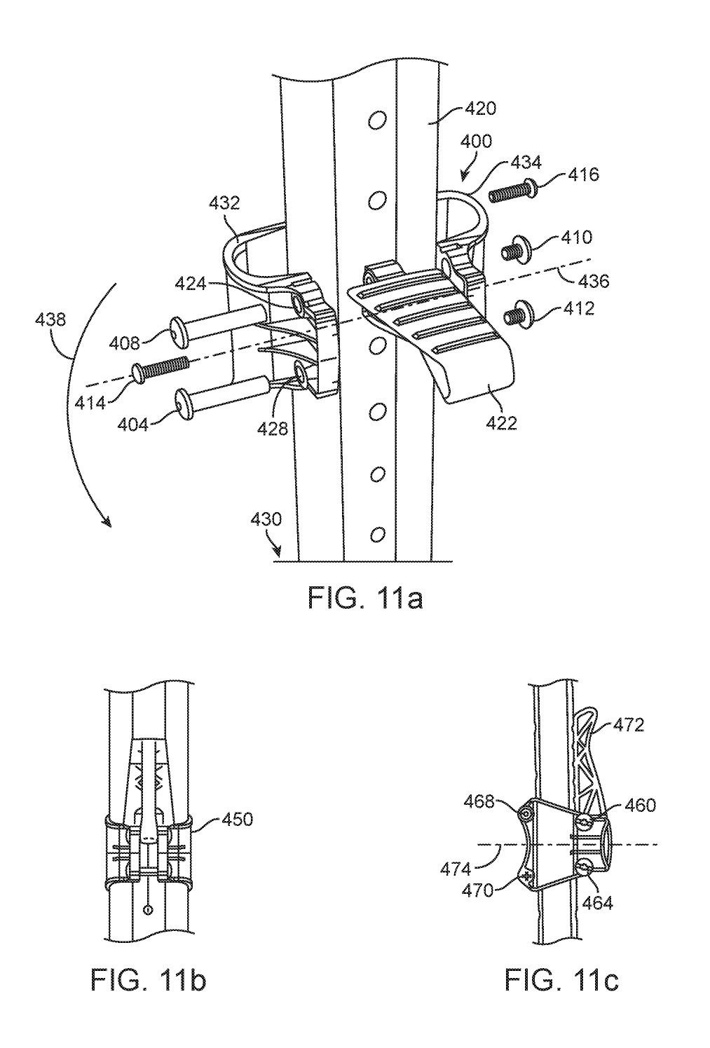

Referring now to FIG. 11a, which shows an exploded view of a two piece collar attachment (400). In this embodiment said two piece collar attachment is secured using two barrel bolts, barrel bolt (404) and barrel bolt (408) respectively, as is known in the art. Barrel bolts, also known as Chicago screws, post and screw, binding posts, offer exemplary performance due to their tight tolerance fitting with the collar attachment through holes through which they are placed. Further said barrel bolts offer exemplary performance as hinges due to their smooth pipe like shapes. Said barrel bolts are secured by screws, screw a (410) and screw b (412), respectfully as is known in the art. Two further screws, screw c (414) and screw d (416), are used to secure the far side of the collar attachment. The use of four attachment screws, two on each side of said collar attachment, insures a secure but detachable attachment to the crutch (420) by way of compression.

It should be noted that said two piece collar attachment (400) has two potential hinges, barrel bolt (404) and barrel bolt (408). Only the top most, where top most is defined as that hinge located most vertical of the two potential hinges, with the two potential hinges being barrel bolt (404) and barrel bolt (408). By most vertical we mean; the hinge located most vertical of the two hinges when measured from the ground to said hinge height when the attachment collar to which they are mounted is positioned on a frame and said frame is positioned essentially perpendicular to the ground. Referring to FIG. 11a, said ground is essentially parallel and below line (430). In this embodiment the barrel bolt (408) is more vertical than barrel bolt (404) and is therefore defined as the most vertical of the two and hence facilitates as the hinge for the leg support arm (422).

As previously described, a two piece collar attachment has two sleeves, a first sleeve (432) and a second sleeve (434) which are essentially identical with one sleeve rotated such that said two sleeves abut against one another in a manner amenable to secure attachment and upon attachment form a compression about a frame, which in this embodiment is a crutch (420). Given the rotational symmetry of the two parts and two potential hinge locations, one hinge location being more vertical than the other, the two piece collar attachment can be rotated about a central axis (436), in a direction shown by arrow (438) thereby enabling use of both potential hinge locations upon rotation. That is, by rotating the two part collar attachment about it's central axis (436) a second potential hinge location is made available to a user. The ability to offer more than one hinge location enables continued use of a single attachment collar even if one hinge location becomes worn due to use or damage. Wear of the hinge location can include, but is not limited to, wearing of the protrusion, divot, ramp, notch or collar itself.

Referring now to FIG. 11b, which shows a side view of a two piece collar attachment (450). The two piece collar attachment, due to its design, allows for secure and detachable attachment to a crutch without disrupting the crutch height adjustment mechanism which is commonly enabled by a depressible button which when engaged locks the crutch at a certain position and when depressed allows adjustment of the crutch height. The gap left between one side of the two piece collar attachment and the other side of the two piece collar attachment results in a gap slightly larger than the aforementioned depressible button. The gap is designed such that it accommodates said depressible button. Further, it should be noted that all embodiments of collar attachments as taught in this innovation are capable of being secured at any position defined by a user just as long as said sufficient compression can be achieved using said attachment collar. As an example, when the frame is a crutch, said collar attachment can be attached anywhere along the lower portion of a crutch as previously defined. It should be further noted that in all embodiments of this innovation, securement does not require any augmentation of the frame upon which it is attached. That is, other than the innovation and all of its components, no screws, bolts, cutting, scoring or changing of the frame upon which the innovation is mounted is required.

Referring now to FIG. 11c which shows a side view a two piece attachment collar secured to a crutch as previously described. Two barrel bolts, top barrel bolt (460) and bottom barrel bolt (464) and two screws, top screw (468) and bottom screw (470) secure the two sleeves of the two piece attachment collar one to the other. The top barrel bolt (460) further facilitates as a hinge for the leg support arm (472) as previously described. Each individual sleeve is symmetric about a central axis (474). It can be seen that a single attachment collar can be rotated 180 degrees about said central axis (474) such that the bottom barrel bolt (464) relocates to the top barrel bolt position, thereby becoming the more vertical of the two barrel bolts thereby offering a second hinge position which can be accessed by simply inverting or rotating the two piece attachment collar such that the bottom barrel bolt location (464) becomes the top barrel bolt. Rotation also results in the two sleeves exchanging sides of the frame.

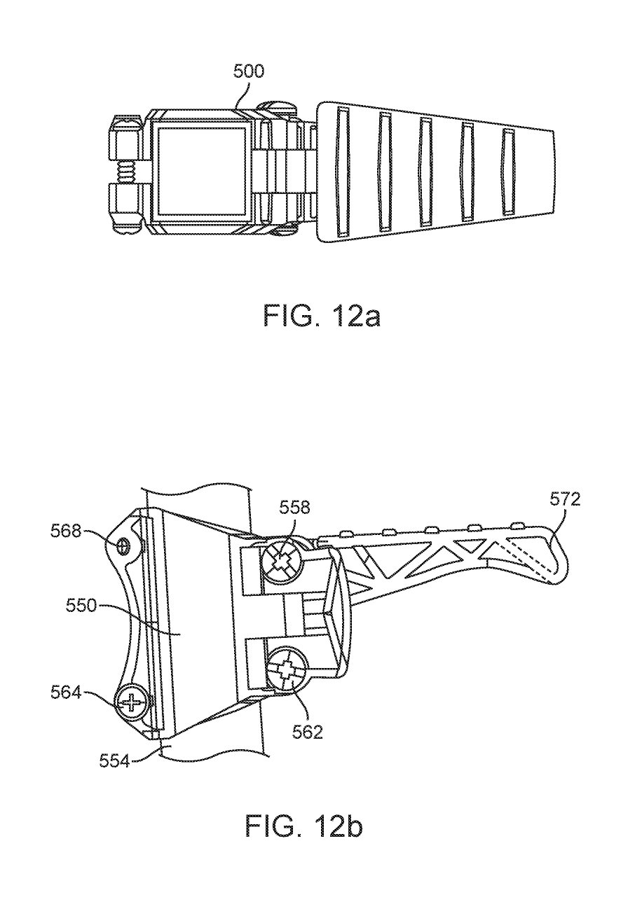

Referring now to FIG. 12a, which shows a top view of a two collar attachment for a square leg (500). In this embodiment, the collar attachment is formed such that it can accommodate a square leg. Square legs are commonly found on tables, chairs, work stations and similar. As previously described, said collar attachment compresses and so securely attaches to a frame upon which it is mounted. Said attachment collar can be attached at any location sufficient compression can be generated between the attachment collar and the frame upon which it is mounted. By sufficient pressure we mean sufficient pressure such that said attachment collar does not move from its location when it's leg support arm is weighted with foot which it is supporting. In this embodiment, a square collar attachment can be secured to a square mounting structure. It should be understood that other geometries are also amenable. That is, a round collar can be mounted on a round structure, a triangular collar can be mounted on a triangular structure, a hexagonal collar can be mounted on a hexagonal structure etc.

Referring now to FIG. 12B shows a side view of a square collar attachment (550) secured to a dimensionally square frame (554). A top barrel bolt (558) and a bottom barrel bolt (562) and a top screw (568) and bottom screw (564) are used to secure the two sleeves to one another and apply the required compression to the square frame (554) providing a secure but detachable mounting of said square collar to said square frame. Said top barrel bolt (558) provides a hinge for a leg support arm (572). As previously described said attachment collar can be flipped or rotated such that the originally bottom barrel bolt becomes the top barrel bolt thereby offering a secondary hinge position if desired by a user.

Although the present invention has been described in considerable detail with reference to certain preferred versions thereof, other versions are possible. Therefore, the spirit and scope of the appended claims should not be limited to the description of the preferred versions contained herein.

### NUMERICAL IDENTIFICATION

(4) crutch frame
(8) top end with a foam pad
(12) handle
(16) central shaft
(18) first end
(20) rubber tip
(24) shaft 1
(28) shaft 2
(32) central shaft top interface
(36) central shaft bottom interface
(40) plane of the bottom bracket
(44) attachment collar
(46) central void
(48) central void length
(52) central void width
(54) central gap
(58) attachment collar flange
(60) crutch gap angle
(70) top nut ingress
(74) bottom nut ingress
(78) leg support shelf
(82) attachment collar bump
(88) top screw ingress
(92) bottom screw ingress
(96) leg support catch
(110) leg support arm
(114) foot support studs
(118) leg support arm central support
(122) right leg support guide bushing
(124) left leg support guide bushing
(126) pivotal end
(128) connection via
(130) leg support divot
(131) top of the leg support arm
(132) angle
(134) engagement side of the leg support arm
(138) leg support arm protrusion
(140) top most edge of the leg support arm
(142) vertical protrusion distance
(144) horizontal protrusion distance
(150) crutch
(170) top securement screw
(174) top securement nut
(178) bottom securement screw
(182) bottom securement nut
(190) flange gap
(194) leg support flange
(210) single node leg support arm
(214) single node attachment collar
(218) securement screw
(222) bottom of said single node leg support arm
(226) bottom of said single node attachment collar
(230) angle of the top of said single node attachment collar
(236) crutch section
(250) backside of the attachment collar
(254) logo position
(270) quick release lever
(274) quick release ingress
(278) cam follower
(282) spring
(286) spring cup
(290) quick release bar
(294) quick release nut
(298) quick release nut ingress
(350) attachment collar
(354) leg support arm
(360) sleeve 1
(364) sleeve 2
(350) two piece collar attachment
(368) locking divot
(372) locking protrusion
(374) ramp
(380) two piece collar attachment
(382) screw hole 1
(384) screw hole 2
(390) sleeve 1
(392) sleeve 2
(386) extra material
(388) extra material
(394) axis a (394)
(396) arrow (396)
(400) two piece collar attachment
(404) barrel bolt
(408) barrel bolt
(410) screw a
(412) screw b
(414) screw c
(416) screw d
(420) crutch
(430) line
(422) leg support arm
(432) first sleeve
(434) a second sleeve
(436) central axis
(438) arrow
(450) two piece collar attachment
(460) top barrel bolt
(464) bottom barrel bolt
(468) top screw
(470) bottom screw
(472) leg support
(474) central axis
(500) square leg
(550) square collar attachment
(554) square frame
(558) top barrel bolt
(562) bottom barrel bolt
(568) top screw
(564) bottom screw
(572) leg support arm

I claim:

1. A leg support comprising:
a leg support arm for supporting a user's leg having a first end and a second end;
an attachment collar for engaging a frame; where said attachment collar is comprised of two sleeves aligned such that they can be secured to one another; attachment devices capable of securing said two sleeves to one another; where said attachment collar can be secured to a frame by means of compression in a firm but detachable fixation at a position defined by a user on said frame; where said leg support arm first end is pivotally connected to said attachment collar at a hinge and said leg support arm can rotate between a vertical position where said leg support arm is substantially parallel to said frame and a horizontal position where said leg support arm is substantially perpendicular to said frame.

2. A leg support according to claim 1, where said two sleeves are substantially identical.

3. A leg support according to claim 1, where said attachment collar has two hinge locations; where a first hinge location is positioned substantially near a top location on said attachment collar and a second hinge location is located substantially near a bottom location on said attachment collar; where said attachment collar is capable of being mounted in either an upright or upside down orientation while maintaining leg support arm functionality when said leg support is pivotally connected to the upper most of the two hinge locations.

4. A leg support according to claim 1, where said frame is chosen from the group consisting of a crutch, a table leg or a chair leg.

5. A leg support according to claim 1, further comprising an angled ramp on said attachment collar, where said angled ramp is positioned such that said leg support arm abuts against said angled ramp thereby increasing pressure between said leg support arm and said attachment collar when said leg support arm is rotated between a substantially parallel orientation to said attachment collar to a substantially perpendicular orientation to said attachment collar and said pressure is released when said leg support arm is positioned substantially parallel to said attachment collar.

6. A leg support according to claim 1, further comprises an angled ramp on said attachment collar, where said angled ramp is positioned such that said leg support arm abuts against said angled ramp thereby increasing pressure between said leg support arm and said attachment collar when said leg support arm is rotated between a substantially parallel orientation to said attachment collar to a substantially perpendicular orientation to said attachment collar and said pressure is released when said leg support arm is positioned substantially perpendicular to said attachment collar.

7. A leg support according to claim 1 wherein the leg support arm produces an angle substantially between 90 and 95 degrees measured between said leg support arm and said frame.

8. A leg support according to claim 1 wherein said attachment collar utilizes a quick release mechanism to apply compression.

9. A leg support according to claim 1 wherein said attachment collar has a logo.

10. A leg support according to claim 1 wherein said leg support arm has foot support studs disposed upon the top side of said leg support arm.

11. A leg support comprising:
a leg support arm for supporting a user's leg having a first end and a second end;
an attachment collar for engaging a frame;
where said attachment collar is comprised of one piece and securement devices capable of securing said attachment collar by means of compression in a firm but detachable fixation at a position on said frame defined by a user;
where said leg support arm first end is pivotally connected to said attachment collar at a hinge;
where said leg support arm can rotate between a generally vertical position where said leg support arm is generally parallel to said frame and a horizontal position where said lateral leg support arm is generally perpendicular to said frame.

12. A leg support according to claim 11, where said frame is chosen from the group consisting of a crutch, a table leg or a chair leg.

13. A leg support according to claim 11, further comprises an angled ramp on said attachment collar, where said angled ramp is positioned such that said leg support arm abuts against said angled ramp thereby increasing pressure between said leg support arm and said attachment collar when said leg support arm is rotated between a substantially parallel orientation to said attachment collar to a substantially perpendicular orientation to said attachment collar and said pressure is released when said leg support arm is positioned substantially parallel to said attachment collar.

14. A leg support according to claim 11, further comprises an angled ramp on said attachment collar, where said angled ramp is positioned such that said leg support arm abuts against said angled ramp thereby increasing pressure between said leg support arm and said attachment collar when said leg support arm is rotated between a substantially parallel orientation to said attachment collar to a substantially perpendicular orientation to said attachment collar and said pressure is released when said leg support arm is positioned substantially perpendicular to said attachment collar.

15. A leg support according to claim 11, wherein the leg support arm produces an angle substantially between 90 and 95 degrees measured between said leg support arm and said frame.

16. A leg support according to claim 11, wherein said attachment collar utilizes a quick release mechanism to apply compression.

17. A leg support according to claim 11, wherein said attachment collar has a logo.

18. A leg support according to claim 11, wherein said leg support arm has foot support studs disposed upon the top side of said leg support arm.
